(19) United States
(12) Patent Application Publication
(10) Pub. No.: US 2002/0163561 A1
(43) Pub. Date: Nov. 7, 2002

(54) Ink container having heaters doped with nitrogen and oxygen

(76) Inventors: Jui-Hua Hu, Tai-Chung Hsien (TW); Chieh-Wen Wang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,442

(22) Filed: Apr. 24, 2002

(30) Foreign Application Priority Data
May 2, 2001 (TW) 090110548

(51) Int. Cl. B41J 2/05

(52) U.S. Cl. 347/62

(57) ABSTRACT

An ink container includes an ink chamber for storing ink, a print head installed below the ink chamber for receiving ink from the ink chamber, an ink channel installed between the ink chamber and the print head for passing ink from the ink chamber to the print head, a nozzle installed below the print head for injecting ink, and a heater installed beside the nozzle for heating ink so as to inject ink through the nozzle. The resistive layer of the heater has essentially refractory material, oxygen and nitrogen.

### BACKGROUND OF INVENTION

1. Field of the invention

The present invention relates to an ink container, and more particularly, to an ink container having heaters doped with nitrogen and oxygen.

2. Description of the Prior Art

Please refer to FIG. 1, FIG. 2, and FIG. 3. FIG. 1 is a diagram of a prior art ink container 10. FIG. 2 is a diagram of a print head 20 of the ink container 10. FIG. 3 is a diagram of a heater 24 of the print head 20. Generally speaking, the ink container 10 is found in an ink jet printer. The ink container 10 comprises an ink chamber 12 for storing ink, and the print head 20 is installed at a bottom side of the ink chamber 12 for receiving ink from the ink chamber 12. As shown in FIG. 2, the print head 20 comprises a plurality of ink channels 16 installed between the ink chamber 12 and the print head 20 for passing ink from the ink chamber 12 to the print head 20, a plurality of nozzles 22 installed at a bottom side of the print head 20 for injecting ink, and a plurality of heaters 24 installed beside the nozzles 22 for heating ink so as to inject ink through the nozzles 22. As shown in FIG. 3, each heater 24 uses a resistive layer 26 connected to a power source as a heat source for heating ink in the print head 20.

In general, the value of the resistive layer 26 is decided by a resistive coefficient of a material the resistive layer 26 is made of, and a thickness of the resistive layer 26.

The higher the resistive coefficient is, the greater the resistive value is. The less the thickness is, the greater the resistive value is. The resistive coefficient changes with temperature, and one expression of this relationship is a thermal coefficient of resistance (TCR). If the modulus of TCR is small, when operating the print head, the resistive value of the resistive layer is not easily affected by the operating temperature.

In U.S. Pat. No. 5,682,188, Hewlett Packard Company discloses a resistive layer of a heater that is composed of doped tantalum (Ta), aluminum (Al), and oxygen (Oₓ). However, this material composition has some shortcomings. The resistive coefficient of TaNₓO_{y} is relatively more sensitive to temperature, so the resistive value is easily affected by the temperature of the environment. Moreover, the process for the TaNₓO_{y} layer is complex, and a following etching process must use poisonous chlorine air. Therefore, it costs too much and it is dangerous.

If doped TaNₓ is used for the resistive layer of the heater, TaNₓ has a lower TCR value, but a disadvantage is relatively short endurance, because the resistive coefficient of TaNₓ is relatively lower. In contrast with materials having a higher resistive coefficient, to achieve the same resistive value, the thickness of the TaNₓ layer must be thinner than the thickness of a layer made of the material with a higher resistive coefficient. Therefore, the endurance of the material with the lower resistive coefficient is shorter because the thickness is thinner.

### SUMMARY OF INVENTION

It is therefore a primary objective of the present invention to provide a resistive layer of a heater that is made of TaN_{X}O_{Y} to increase an endurance of the resistive layer of the heater.

According to the claimed invention, an ink container includes an ink chamber for storing ink, a print head installed below the ink chamber for receiving ink from the ink chamber, an ink channel installed between the ink chamber and the print head for passing ink from the ink chamber to the print head, a nozzle installed below the print head for injecting ink, and a heater installed beside the nozzle for heating ink so as to inject ink through the nozzle. The resistive layer of the heater consists essentially of refractory material, oxygen and nitrogen.

It is an advantage of the present invention that the sensitivity of the resistive layer to the temperature of the environment is reduced and the endurance of the resistive layer is extended.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a diagram of a prior art ink container.

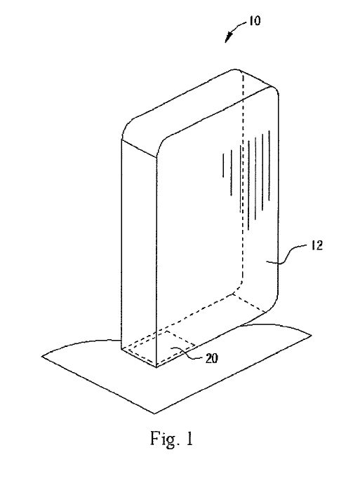

FIG. 2 is a diagram of a print head of the ink container in FIG. 1.

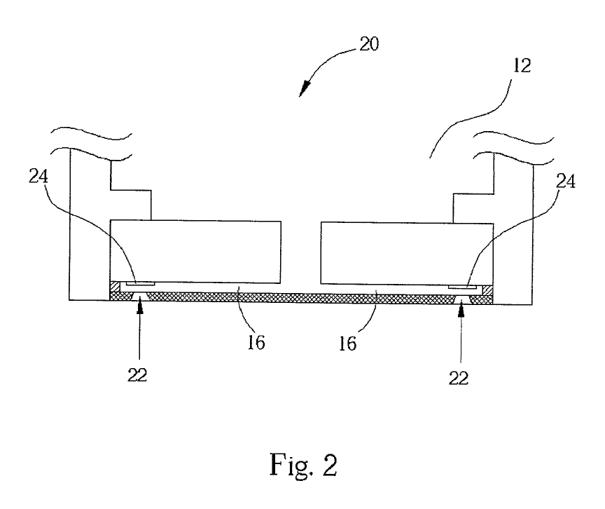

FIG. 3 is a diagram of a heater of the print head in FIG. 2.

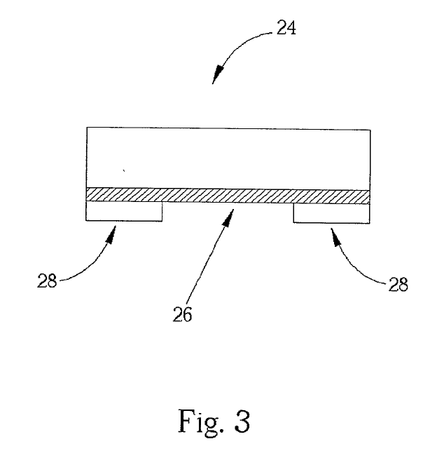

FIG. 4 is a diagram of the present invention ink container.

FIG. 5 is a diagram of a print head of the ink container in FIG. 4.

FIG. 6 is a diagram of a heater of the print head in FIG. 5.

### DETAILED DESCRIPTION

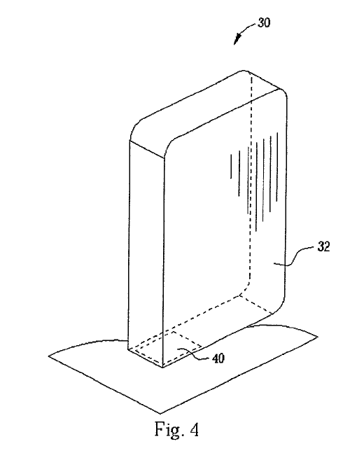

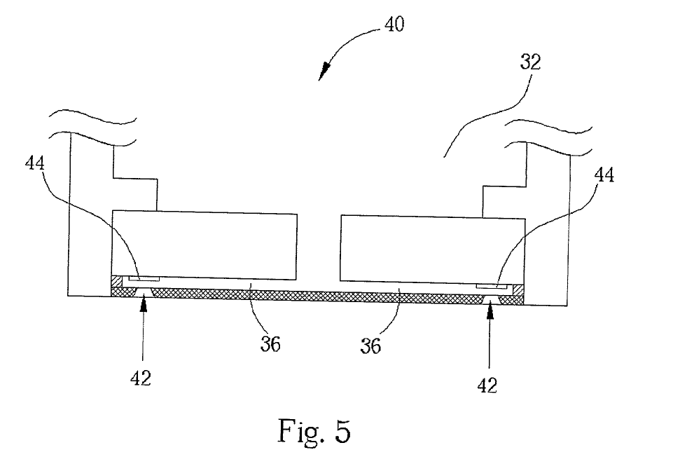

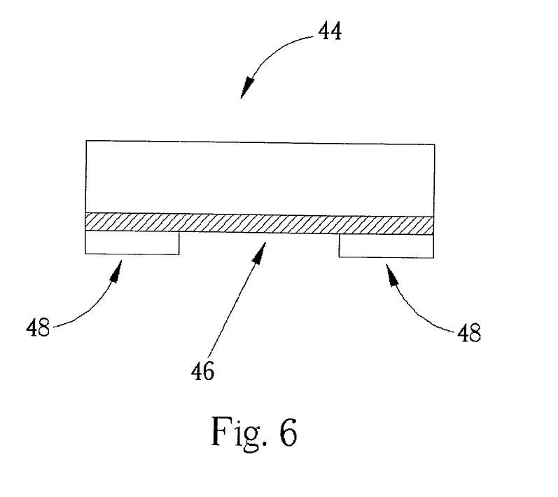

Please refer to FIG. 4, FIG. 5, and FIG. 6. FIG. 4 is a diagram of the present invention ink container 30. FIG. 5 is a diagram of a print head 40 of the ink container 30 in FIG. 4.

FIG. 6 is a diagram of a heater 44 of the print head 40 in FIG. 5. As shown in FIG. 4, the ink container 30 comprises an ink chamber 32 for storing ink, the print head 40 is installed at a bottom side of the ink chamber for receiving ink from the ink chamber 32. As shown in FIG. 5, the print head 40 comprises a plurality of ink channels 36 installed between the ink chamber 32 and the print head 40 for passing ink from the ink chamber 32 to the print head 40, a plurality of nozzles 42 installed at a bottom side of the print head 40 for injecting ink, and a plurality of heaters 44 installed beside the nozzles 42 for heating ink so as to inject ink through the nozzles 42. As shown in FIG. 6, each heater 44 uses a resistive layer 46 connected to a power source as a heat source for heating ink in the print head 40.

Generally speaking, the resistive value of the resistive layer is decided by its resistive coefficient and thickness. The higher the resistive coefficient is, the greater the resistive value is, and theless the thickness is, the greater the resistive value is. As regards endurance, under the same current, the thicker the resistive layer of the heater is, the longer is the endurance of the resistive layer. The resistive value is related to not only the thickness of the resistive layer, but also to temperature, because the resistive coefficient changes with temperature. This relationship is expressed by a constant called a thermal coefficient of resistance (TCR). If the modulus of TCR is small, then the resistive coefficient is not easily affected by temperature.

The first preferred embodiment of the present invention provides a TaNₓO_{y} layer as the resistive layer 46 of the heater 44, wherein 0.1% to 15% of total atomic weight is oxygen (O). In contrast to the prior art TaAIOₓ resistive layer, the nitrogen element of the TaNₓO_{y} layer can be used to reduce the TCR value of TaNₓO_{y}, thereby reducing the sensitivity of the resistive value to the temperature of the environment. Additionally, the heater 44 is only doped with tantalum, as opposed to tantalum and aluminum, so the process is simplified.

Furthermore, in contrast to the prior art TaNₓ resistive layer, the resistive coefficient of the TaNₓO_{y} layer is higher than the resistive coefficient of the TaNₓ layer, so the heater resistive layer made of TaNₓO_{y} can be made thicker to extend the endurance of the resistive layer.

Aside from using TaNₓO_{y} for the resistive layer, using any doped refractory material, nitrogen, and oxygen to form the resistive layer fits the teaching of the preferred embodiment. By using nitrogen, the resistive layer has the advantage of low TCR. By using oxygen, the thickness of the resistive layer can be increased to raise the endurance of the heater.

In contrast to the resistive layer of the prior art heater, the resistive layer 46 is doped with the refractory material, nitrogen, and oxygen. Therefore, the resistance of the resistive layer is relatively insensitive to changes in temperature, and has a longer endurance as a result of being relatively thicker.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An ink container comprising:
an ink chamber for storing fluid;
a print head installed at bottom of the ink chamber for receiving fluid from the ink chamber;
an ink channel installed between the ink chamber and the print head for passing fluid from the ink chamber to the print head;
a nozzle installed at a bottom side of the print head for injecting fluid; and
a heater installed beside the nozzle for heating fluid so as to inject fluid through the nozzle, the heater including a resistive layer having refractory material doped with oxygen and nitrogen.

2. The ink container of claim 1 wherein the refractory material is tantalum (Ta).

3. The ink container of claim 1 wherein 0.1% to 15% of total weight of the resistive layer is oxygen.
